(19) United States
(12) Patent Application Publication
(10) Pub. No.: US 2011/0186658 A1
(43) Pub. Date: Aug. 4, 2011

(54) IRRIGATION SYSTEM AND NOZZLE ASSEMBLY AND METHODS THEREOF

(76) Inventor: David B. Wuchert, Dolores, CO (US)

(21) Appl. No.: 13/018,984

(22) Filed: Feb. 1, 2011

Related U.S. Application Data
(60) Provisional application No. 61/300,303, filed on Feb. 1, 2010.

(51) Int. Cl. B05B 3/18; B23P 19/00; F16L 41/00

(52) U.S. Cl. 239/723; 29/428; 285/143.1

(57) ABSTRACT

A nozzle assembly for an irrigation system, including: a first portion arranged for connection to a device external to the nozzle assembly, the first portion including a first bore open to a distal end of the first portion; and a second portion including: a first chamber in communication with the first bore; and at least one second bore at an acute angle with respect to a longitudinal axis for the nozzle assembly. The longitudinal axis passes through the first and second portions. The at least one second bore includes: a first port in communication with the first chamber; and a second port at an external surface of the second portion.

### CROSS-REFERENCE TO RELATED APPLICATIONS

This application claims the benefit under 35 U.S.C. §119(e) of U.S. Provisional Application No. 61/300,303, filed Feb. 1, 2010, which application is incorporated herein by reference.

### FIELD OF THE INVENTION

The invention relates generally to an irrigation system including a flexible hose with a plurality of bushings through a wall of the hose and suitable for accepting a variety of fittings and nozzles. The invention also relates generally to a nozzle assembly with angled outlets.

### BACKGROUND OF THE INVENTION

Irrigation systems using rigid piping or tubing are known. Configurations and layouts of these systems cannot be quickly or efficiently changed due to the rigidity of the piping or tubing. In some cases the piping or tubing is buried, further increasing the cost and lack of flexibility for these systems.

### SUMMARY OF THE INVENTION

According to aspects illustrated herein, a there is provided a nozzle assembly for an irrigation system, including: a first portion arranged for connection to a device external to the nozzle assembly, the first portion including a first bore open to a distal end of the first portion; and a second portion including: a first chamber in communication with the first bore; and at least one second bore at an acute angle with respect to a longitudinal axis for the nozzle assembly. The longitudinal axis passes through the first and second portions. The at least one second bore includes: a first port in communication with the first chamber; and a second port at an external surface of the second portion.

According to aspects illustrated herein, a there is provided a method of forming an irrigation system, including: forming at least one hole through a wall of a flexible hose into an interior passageway formed by the wall; disposing a first section of at least one attachment element in the at least one hole, the first section located at a first end of the at least one attachment element; fixing the at least one attachment element with respect to the hose; providing a bore in the at least one attachment element in communication with the passageway and a second end of the attachment element, opposite the first end of the attachment element; and connecting a plug or a water dispensing device to the second end.

According to aspects illustrated herein, a there is provided an irrigation system, including: a flexible hose including: a wall forming an interior passageway; and at least one hole through the wall to the interior passageway. The system includes at least one attachment element connected to the flexible hose and including: a first section at a first end of the at least one attachment element, the first section at least partially disposed in the at least one hole and including an connection feature for fixing the attachment element with respect to the hose; a second section at a second end of the at least one attachment element, opposite the first end, arranged to receive a plug or a water dispensing device; and a bore connecting the first and second ends, wherein each bore is in communication with the interior passageway.

According to aspects illustrated herein, a there is provided a method of forming an irrigation system, including: forming at least one hole through a wall of a flexible hose into an interior passageway formed by the wall; disposing a first section of at least one attachment element in the at least one hole, the first section located at a first end of the at least one attachment element; fixing the at least one attachment element with respect to the hose; providing a bore in the at least one attachment element in communication with the passageway and a second end of the attachment element, opposite the first end of the attachment element; and connecting a plug or a water dispensing device to the second end.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of an irrigation system with attachment elements and nozzle assemblies installed on a hose;

FIG. 2 is a side view of the irrigation system shown in FIG. 1;

FIG. 3 is a plan view of the irrigation system shown in FIG. 1;

FIG. 4 is an end view of the irrigation system shown in FIG. 1;

FIG. 5 is an exploded side view of an attachment element and nozzle assembly shown in FIG. 1;

FIG. 6 is a cross-sectional view of a nozzle assembly shown in FIG. 1 generally along line 6-6 in FIG. 3;

FIG. 7 is an exploded view of a spray head aspect of a nozzle assembly;

FIG. 8 is a half cross-section of the outer sleeve shown in FIG. 7;

FIG. 9 is a half cross-section of the inner portion shown in FIG. 7;

FIG. 10 is an exploded side view of a nozzle assembly with a staking element; and,

FIG. 11 is a perspective view of the irrigation system shown in FIG. 1 with the staking element shown in FIG. 10.

### DETAILED DESCRIPTION OF THE PREFERRED EMBODIMENT

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention.

Unless defined otherwise, all technical and scientific terms used herein have the same meaning as commonly understood to one of ordinary skill in the art to which this invention belongs. It should be understood that methods, devices or materials similar or equivalent to those described herein can be used in the practice or testing of the invention.

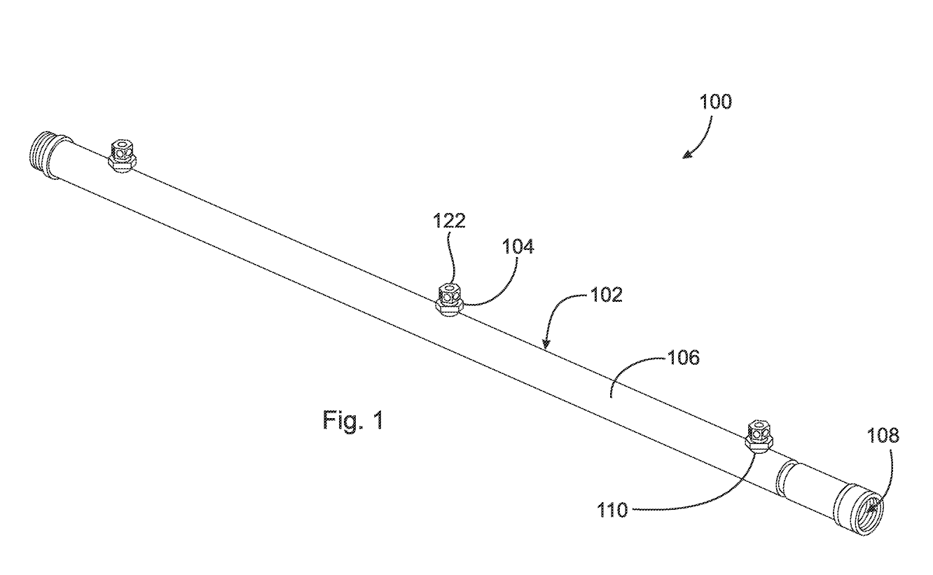

FIG. 1 is a perspective view of irrigation system 100 with attachment elements and nozzle assemblies 102 installed on a hose.

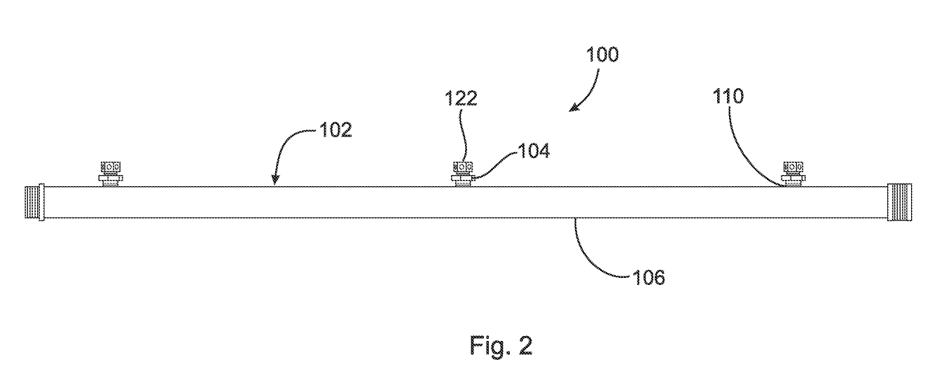

FIG. 2 is a side view of irrigation system 100 shown in FIG. 1.

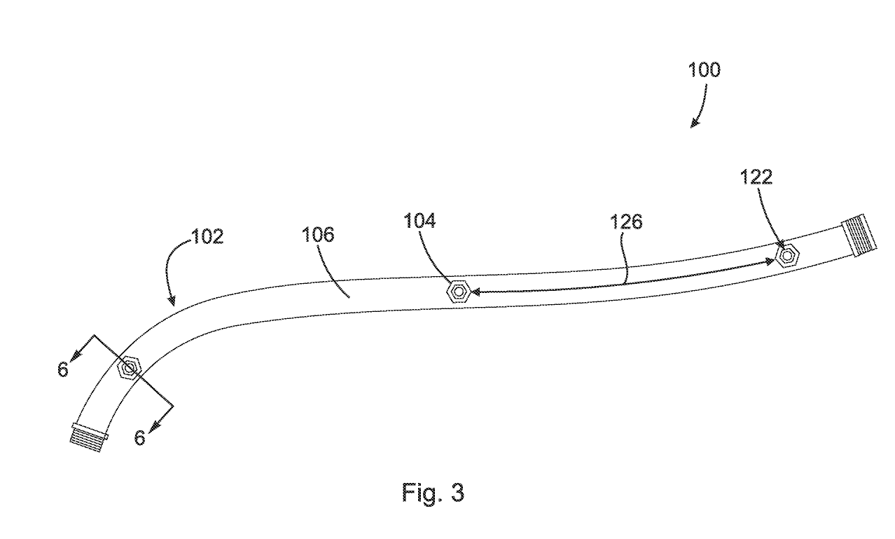

FIG. 3 is a plan view of irrigation system 100 shown in FIG. 1.

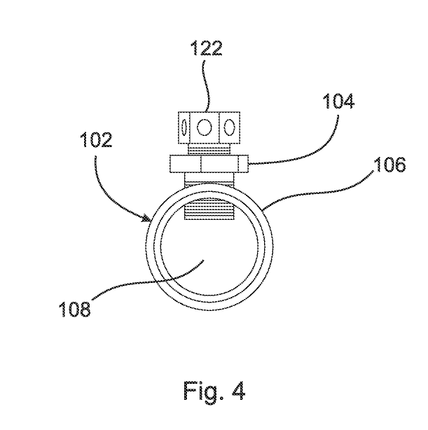

FIG. 4 is an end view of irrigation system 100 shown in FIG. 1.

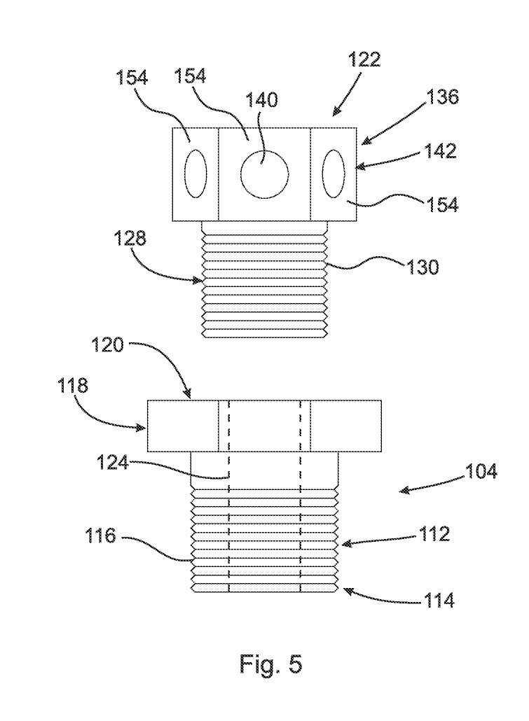

FIG. 5 is an exploded side view of an attachment element and nozzle assembly shown in FIG. 1. The following should be viewed in light of FIGS. 1 through 4. Integrated nozzle hose system 100 includes flexible hose 102 and at least one attachment element 104 connected to the hose. By flexible hose, we mean a hose that is able to be flexed, bent, or coiled, for example, a flexible hose can be bent or flexed by more than 10 degrees with respect to a longitudinal axis of the hose. For example, a rigid steel, aluminum, PVC, or ABS pipe or tube is not a flexible hose. The hose includes wall 106 forming interior passageway 108 and at least one hole 110 through the wall to interior passageway. The attachment element includes section 112 at end 114. Section 112 is at least partially disposed in the hole 110 and fixed with respect to the hose. In an example embodiment, section 112 is engaged directly with the wall so that element 104 is firmly held by the wall. In an example embodiment, section 112 includes a thread, for example, helical thread, 116 matingly engaged with the wall. In an example embodiment (not shown), an intervening device, such as a sleeve, is secured in the hole and section 112 is fixed to the intervening device, for example, by a helical thread. By “helical thread” of “thread” we mean any pipe or plumbing fitting thread known in the art. For example, a helical thread can be considered a continuous V-shaped thread that wraps around an exterior surface or an interior surface. The surface upon which the helical thread is disposed may be straight or tapered.

Element 104 includes section 118 at end 120 of the attachment element, opposite end 114. Section 118 is arranged to receive a plug or a water dispensing device, for example, nozzle assembly 122 further described below. Element 104 also includes bore 124 connecting the ends 114 and 120 and in communication with passageway 108. For example, water is able to pass through the bore to a water dispensing device attached to element 104. In an example embodiment, bore 124 is threaded, for example, there is an internal helical thread, at section 118 to receive the plug or water dispensing device. In an example embodiment (not shown), there is an exterior thread at section 118 to receive the plug or water dispensing device. System 100 is not limited to a particular distance 126 between holes or any particular combination of distances 126. For example, some or all of distances 126 can be the same or can vary. System 100 is further described infra.

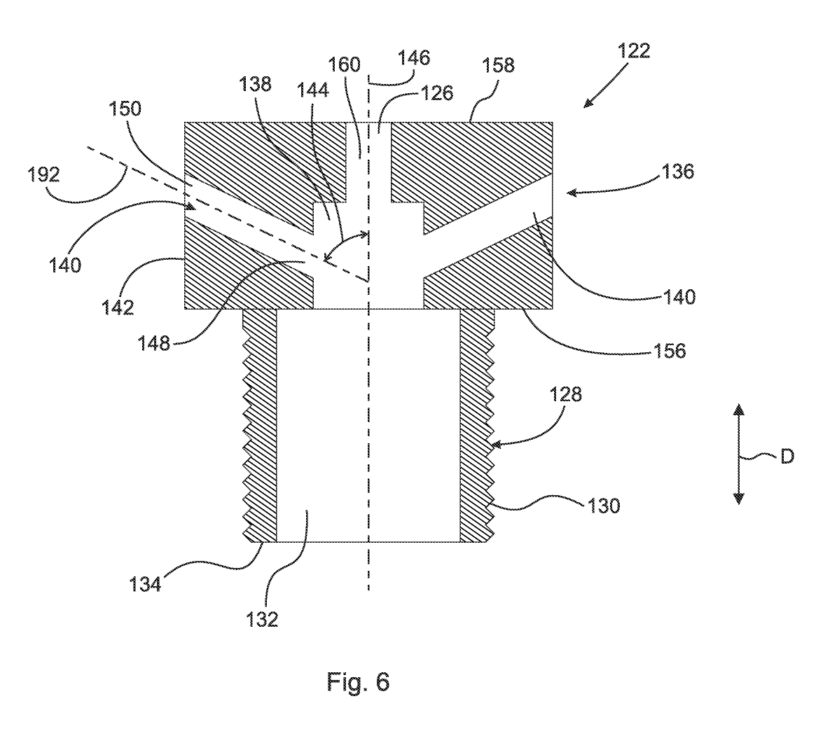

FIG. 6 is a cross-sectional view of nozzle assembly 122 shown in FIG. 1 generally along line 6-6 in FIG. 3. The following should be viewed in light of FIGS. 1 through 6. The nozzle assembly includes portion 128 arranged for connection to a device external to the nozzle. In an example embodiment, portion 128 is cylindrical in shape and includes helical thread 130 formed in an exterior surface of portion 128. Portion 128 includes bore 132 open to distal end 134 of the portion. The nozzle assembly also includes portion 136 including chamber 138 in communication with bore 132, and at least bore 140 in communication with chamber 138 and external surface 142 of portion 136. Bore 140 is at acute angle 144 with respect to longitudinal axis 146 for the nozzle assembly, which passes through portions 128 and 136. In an example embodiment, angle A is about 45 degrees; however, it should be understood that angle A is not limited to any particular angle. In an example embodiment, the axis passes through bore 132 and portions 128 and 136 and chamber 138 are symmetrical with respect to the axis.

In an example embodiment, the nozzle assembly includes a plurality of bores 140. In an example embodiment, port 148 of bore 140 opens to chamber 138, port 150 of bore 140 opens to surface 142, and port 148 is closer, in direction D, parallel to the longitudinal axis, than port 150 to portion 128. That is, bore 140 slants up and away from portion 128. In an example embodiment, external surface 142 includes a plurality of planar surfaces 154 parallel to the longitudinal axis or at acute angle with respect to the axis. In an example embodiment, surface 142 includes six planar surfaces 154. Although nozzle assembly 122 is shown with a particular number of planar surfaces, it should be understood that the nozzle assembly is not limited to a particular number or configuration of planar surfaces. In an example embodiment, a respective bore 140 is disposed between chamber 138 and each planar surface, that is, each planar surface includes a port 150. In an example embodiment, a respective bore 140 is disposed between chamber 138 and in at least one planar surface, but in less than all of the planar surfaces. That is, there is no bore 140 or port 150 for at least one planar surface. In an example embodiment, portion 136 includes bottom end 156 connected to portion 128, top end 158, opposite, in direction D, the bottom end, and bore 160 in communication with chamber 138 and exterior surface 142. In an example embodiment, the axis passes through bore 160.

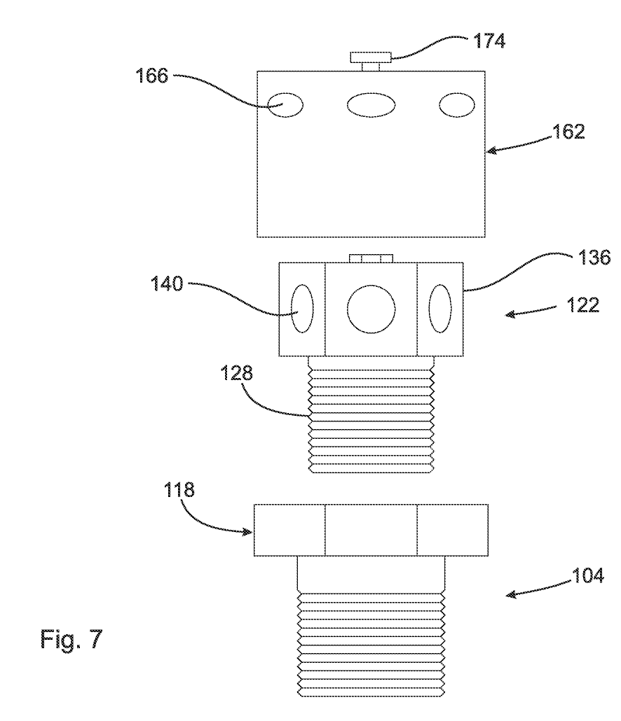

FIG. 7 is an exploded view of a spray head aspect of nozzle assembly 122.

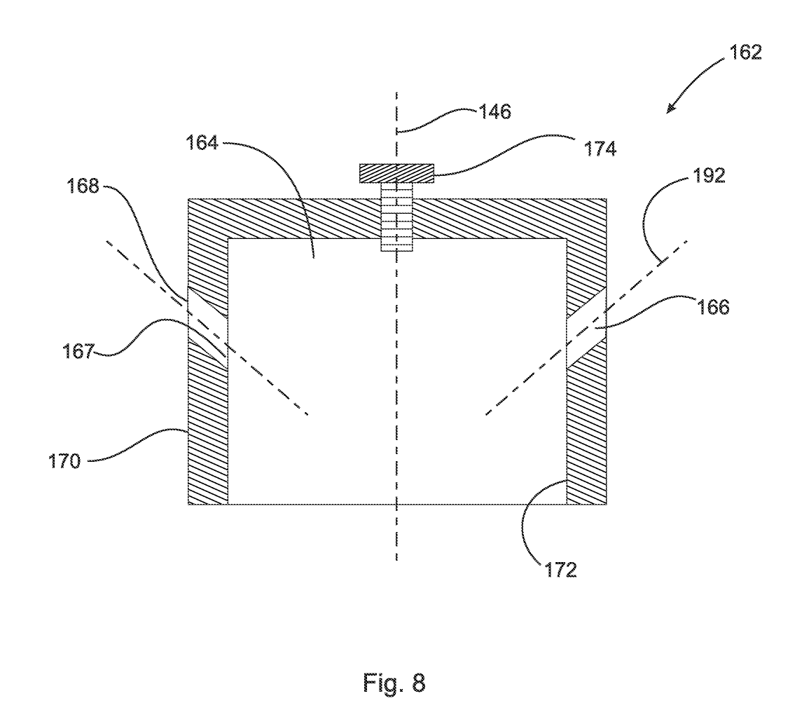

FIG. 8 is a cross-section of the sleeve portion shown in FIG. 7.

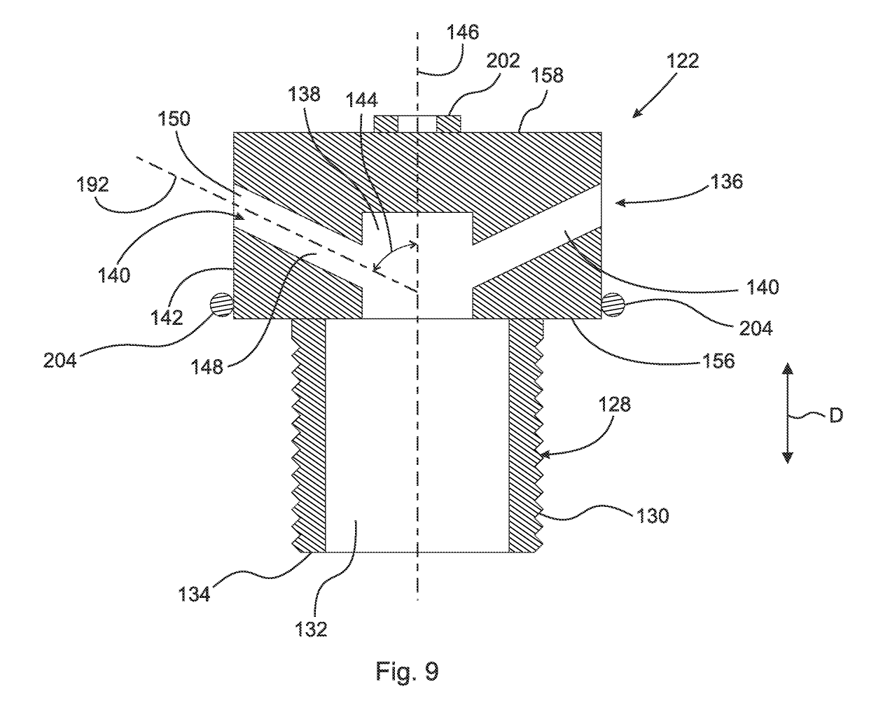

FIG. 9 is a cross-section of the inner portion shown in FIG. 7. The following should be viewed in light of FIGS. 1 through 9. In an example embodiment, the nozzle assembly includes sleeve portion 162 including chamber 164 and at least one bore 166 with port 167 in communication with chamber 164 and port 168 in communication with external surface 170 of the sleeve portion. Portion 136, which can be considered an inner portion for the arrangement shown in FIG. 7, is at least partially disposed in chamber 164, that is, the sleeve portion fits over at least a part of portion 136. Port 167 of bore 166 is alignable, in a direction P, orthogonal to the longitudinal axis, with port 150 of bore 140. In an example embodiment, bore 166 is at acute angle A with respect to longitudinal axis 146 for the nozzle assembly. In an example embodiment, angle A is about 45 degrees; however, it should be understood that angle A is not limited to any particular angle.

In an example embodiment, external surface 142 forms a cylinder aligned with the longitudinal axis and internal surface 172 is formed as a cylinder aligned with the longitudinal axis. In an example embodiment, the sleeve portion is rotatable about the longitudinal axis to adjust alignment the sleeve portion with portion 136, for example, the alignment of ports 167 and 150, and the sleeve portion includes locking component 174 to fix the sleeve portion with respect to portion. In an example embodiment, component 174 is a set screw threaded into the sleeve portion and displaceable to engage portion 136. In general, nozzle assembly 122 as shown in FIG. 5 and nozzle assembly 122 as shown in FIG. 7 can be used interchangeably, for example, in system 100. For example, respective portions 128 are sized and configured the same so as to enable both versions of the nozzle assembly to thread into the same element 104.

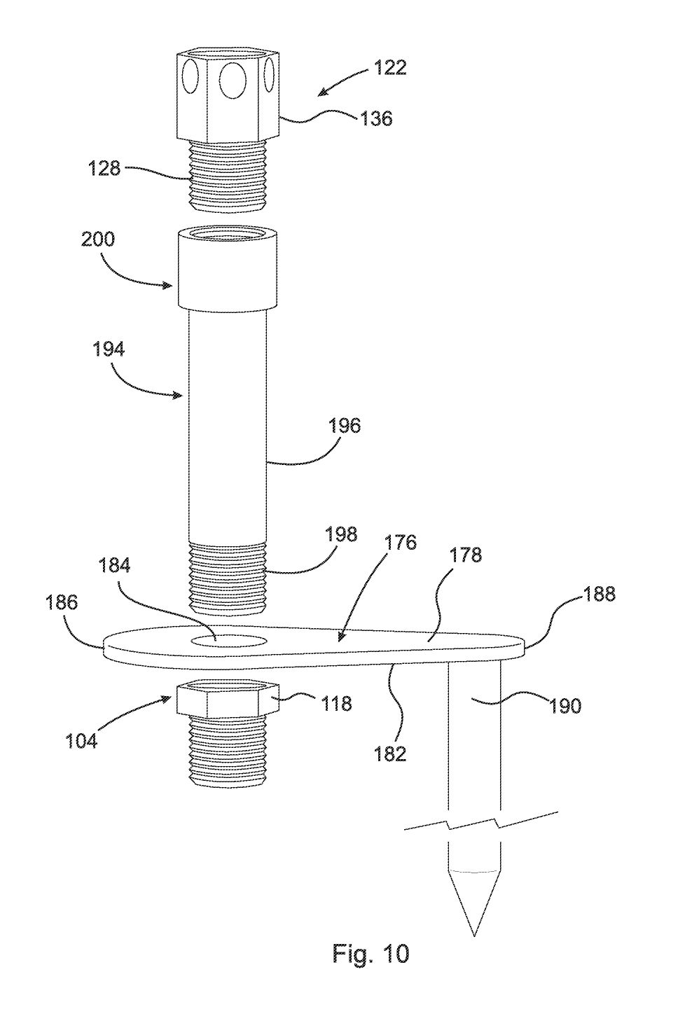

FIG. 10 is an exploded side view of a nozzle assembly with a staking element.

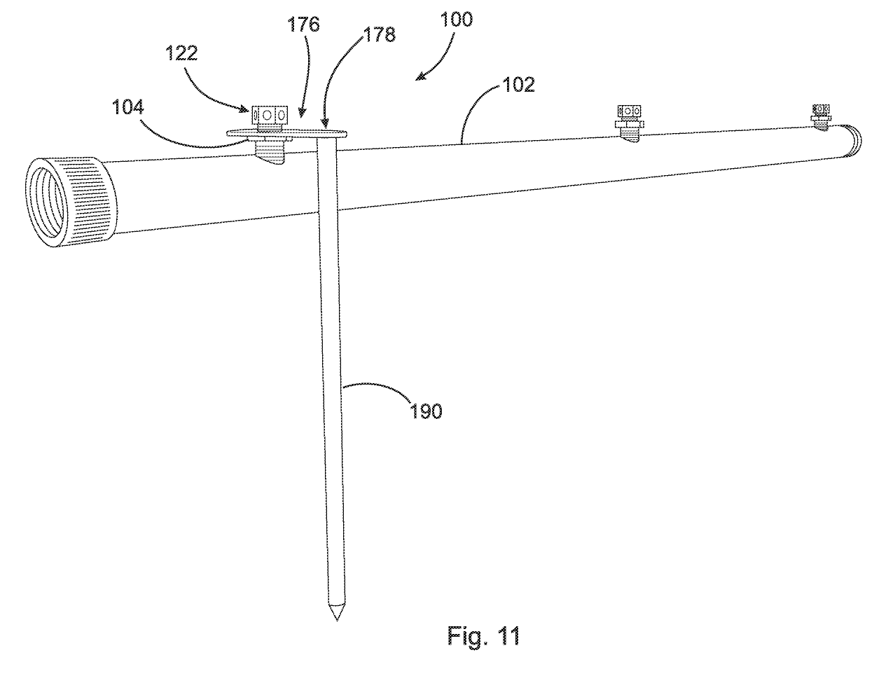

FIG. 11 is a perspective view of irrigation system 100 shown in FIG. 1 with the staking element shown in FIG. 10. The following should be viewed in light of FIGS. 1 through 11. In an example embodiment, the nozzle assembly includes staking element 176 including segment 178 with top surface 180 and bottom surface 182. Segment 178 includes hole 184 connecting the top and bottom surfaces proximate end 186 for segment 178. Segment 178 also includes end 188, opposite end 186. The staking element includes stake portion 190 connected to the bottom surface proximate end 188 and extending away from the bottom surface, for example, in direction D. Part of the portion 128 is arranged to be disposed in hole 184 such that securing portion 128 to a connecting element, for example, attachment element 104, fixes segment 178 with respect to portion 128 and the connecting element. The stake portion is arranged to be disposed in a structure to fix a position of the nozzle assembly. For example, if the nozzle assembly is connected to hose 102 via element 104 and the hose is lying on the ground, the stake portion is driven into the ground to fix a position of the hose and the nozzle assembly.

Further details regarding system 100 and nozzle assembly 122 are now provided. In an example embodiment, element 104 is a double threaded bushing, for example, threaded into hose 102. In one embodiment, the at least one bushing is permanently threaded and bonded into the hose. A threaded water dispensing device, such as nozzle assembly 122 and/or a plug can be threaded into each bushing 104. System 100 is not limited to any particular type or size of hose. System 100 is not limited to any particular number, spacing, configuration, location, or orientation of elements 104. In one embodiment, openings 110 are pre-formed and the bushings are installed prior to placing the system in the field. In one embodiment, openings 110 are formed in the field and elements 104 are installed in the field.

Bores 140 and 166, and ports 148, 150, 167, and 168 are not limited to a particular cross-sectional or longitudinal shape, size, or configuration. Bores 140 and 166, and ports 148, 150, 167, and 168 are not limited to any particular symmetry or configuration with respect to longitudinal axis 192. For example, a diameter of a bore 140 or 166 may be uniform for the bore or may vary along the axis, for example, bore 140 or 166 may taper. Bores 140 and 166, and ports 148, 150, 167, and 168 can be sized and configured according to particular requirements, for example, to create spray patterns from large droplets to a fine mist and dispersion patterns from wide to narrow. This broad versatility provides a variety of watering options ranging from home lawn and home garden use to commercial gardening, to commercial nursery operations, to commercial agricultural operations such as the irrigation of hay fields and many other applications.

One or more staking elements 176 can be employed to position the hose in various configurations while keeping device attached to elements 104 in a desired orientation, for example, vertically upright. In one embodiment, segment 178 is placed on segment, or head, 118 of bushing 104 and portion 128 of a nozzle assembly is placed through opening 184 and threaded into the bushing. By tightening portion 128 in the bushing, portion 178 is snuggly held between segment, or head, 136 of the nozzle assembly and head 118 of the bushing.

Although a particular size, shape, and configuration is shown for stake portion 190, it should be understood that stake portion 190 is not limited to the size, shape, and configuration shown. Pipe stem 194 can be used with system 100, for example, in conjunction with a nozzle assembly and staking element 176. For example, portion 196 can be placed through opening 184 and threaded portion 198 can be threaded into element 104, as described for the nozzle assembly. Then, a device, such as a nozzle assembly can be threaded into end 200 of the stem. In this manner, the device can be positioned above vegetation or other obstacles that would interfere with the dispersal of fluids through bores 140 or 160, while being maintained in an upright position by the staking element.

In one embodiment, element 104 is a reducer, for example, a ¾ inch to ½ inch reducer, which enables devices of different diameters be threaded into element 104 permanently installed in the wall of the hose.

In an example embodiment, ports 150 and 167 are precision sized water ejection ports. Alignment of ports 150 and 167 is performed by rotating the sleeve element with respect to portion 136. The matching of ports 150 and 167 can be 100% for a full spray pattern or any degree in-between for varying amounts of water atomization. In one embodiment, tightening screw 174 installed through the top of the sleeve into threaded bushing 202 mounted in the top of portion 136 is employed to secure each setting by fixing the sleeve portion to portion 136. In one embodiment, O ring 204 is installed on the bottom portion of portion 136 to prevent leakage from the bottom of the sleeve portion.

Advantageously, assembly 122 can replace the single sprinkler traditionally attached to the end of irrigation hoses eliminating the need for frequent moving of the sprinkler to accomplish full area watering. Additionally, the low profile spray pattern of the spray nozzle, the multiple positioning of the nozzle openings and the ability to vary the size of the opening for specialized watering, results in more efficient dispersion of water to targeted areas, thereby minimizing evaporative losses and conserving significant amounts of water. An example of this is the watering of xeriscaping where plugs are used to block off watering where it is not needed, allowing the application of water only where it is needed.

The inherent flexibility of hose 102 permits molding the hose to various configurations i.e. circular, oval or S shape etc. to conform to irregular lawn and garden areas. For straight line watering hose lengths can be extended to several hundred feet limited only by water pressure.

Advantageously, system 100 and nozzle assembly 122 have a great deal more versatility than existing irrigation systems. For example, due to the unique design of nozzle assembly 122, and the ability to vary the configuration of assembly 122, system 100 and nozzle assembly 122 are functionally adaptable to the application of liquid fertilizers, herbicides and pesticides, each of which requires different droplet sizes and different dispersion patterns such as when directed to the root system, the leaf system or to both. For example, larger droplet sizes are required for root application with a mist required for leaf application. For example, angle A, bores 140 or 166, or ports 148, 150, 167, or 168 can be configured to satisfy the requirements of the fluid being dispersed and the target requirements for the fluid.

System 100 and nozzle assembly 122 also have the following advantages:
Use of flexible hose, not rigid piping or tubing. Easily relocated to different use areas and is easily drained and stored, for example, for winter storage. No need to blow out stationary piping or tubing
Hose 102 is aboveground—eliminates expensive, inaccessible, and complex systems with pup-up sprinkler heads.
Can use a double threaded bushing threaded directly into the hose for the installation of various water dispensing devices, such as assembly 122.
Hose 102 can be continuous—not multiple short pieces of hose used to connect individual water dispensing devices.
Usable for both home lawns and gardens as well as large scale commercial application including flood irrigation of large area field crops.
Can be configured to accept virtually any available water dispensing device through the use of commonly available adapters.
Can accept fogging and misting nozzles for the application of fertilizers, herbicides, and pesticides.
Optimal flexibility for locating and installing attachment elements 104. Elements 104 can be easily and quickly installed in the hose. Locations that are no longer desirable can be easily plugged.
System can be easily configured to account for field conditions. For example, water dispensing devices such as assembly 122 can be installed with progressively larger bores 140 or 166 as the distance of the devices from the water source increases. This flexibility equalizes the output of the system to compensate for differences in water pressure and flow rate related to the distance from the water source.
Plugs can be easily installed to control areas being treated.
Plugs can be used to convert hose 102 into a conventional use hose.
Versatility enables maximum efficiency and conservation of water. Angle of bores 140 and 166 minimize evaporative loss.
Low cost of manufacture. Flexible hose is much less expensive that comparatively sized rigid piping or tubing.
Lower cost of operation. For example, less expensive to install and use than gated irrigation systems for field crops.

Thus, it is seen that the objects of the invention are efficiently obtained, although changes and modifications to the invention should be readily apparent to those having ordinary skill in the art, without departing from the spirit or scope of the invention. Although the invention is described by reference to various embodiments, it is clear that variations can be made without departing from the scope or spirit of the invention.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art.

What I claim is:

1. A nozzle assembly for an irrigation system, comprising:
a first portion arranged for connection to a device external to the nozzle assembly, the first portion including a first bore open to a distal end of the first portion; and,
a second portion including:
a first chamber in communication with the first bore; and,
at least one second bore at an acute angle with respect to a longitudinal axis for the nozzle assembly, the longitudinal axis passing through the first and second portions, and the at least one second bore including:
a first port in communication with the first chamber; and,
a second port at an external surface of the second portion.

2. The nozzle assembly of claim 1 wherein:
the first portion is cylindrical in shape;
the first portion includes an exterior surface with a helical thread; and,
the longitudinal axis passes through the first bore.

3. The nozzle assembly of claim 1 wherein the at least one second bore includes a plurality of second bores.

4. The nozzle assembly of claim 1 wherein the first port is closer, in a direction parallel to the longitudinal axis, than the second port to the first portion.

5. The nozzle assembly of claim 1 wherein:
the external surface of the second portion includes a plurality of planar surfaces parallel to the longitudinal axis or at an acute angle with respect to the longitudinal axis;
the at least one second bore includes a plurality of second bores; and,
a respective second port from the plurality of second bores is disposed in each planar surface from the plurality of planar surfaces.

6. The nozzle assembly of claim 1 wherein:
the external surface of the second portion includes a plurality of planar surfaces parallel to the longitudinal axis or at an acute angle with respect to the longitudinal axis; and,
respective second ports from the at least one second bore are disposed in at least one but not every planar surface from the plurality of planar surfaces.

7. The nozzle assembly of claim 1 further comprising a sleeve portion, including:
a second chamber; and,
at least one third bore with:
a third port in communication with the second chamber; and,
a fourth port at an external surface of the sleeve portion, wherein:
the second portion is at least partially disposed in the second chamber; and,
the third port is alignable, in a direction orthogonal to the longitudinal axis, with the second port.

8. The nozzle assembly of claim 7 wherein:
the external surface of the second portion forms a cylinder aligned with the longitudinal axis;
the second chamber is formed by a cylindrical surface aligned with the longitudinal axis;
the sleeve portion is rotatable about the longitudinal axis; and,
the sleeve portion includes a locking component to fix a position of the sleeve portion with respect to the second portion.

9. The nozzle assembly of claim 1 wherein the second portion includes a bottom end connected to the first portion and a top end opposite, in a direction parallel to the axis, the bottom end, the nozzle assembly further comprising a third bore in communication with the first chamber and the exterior surface of the second portion at the top end.

10. The nozzle assembly of claim 1 further comprising a staking element, including:
a first segment including:
top and bottom surfaces;
a hole connecting the top and bottom surfaces proximate a first end for the first segment; and,
a second end, opposite the first end; and,
a stake portion connected to the bottom surface proximate the second end and extending away from the bottom surface, wherein:
a part of the first portion is arranged to be disposed in the hole such that securing the first portion to a connecting element fixes the first segment with respect to the first portion and the connecting element; and,
the stake portion is arranged to be disposed in a structure to fix a position of the nozzle assembly.

11. An irrigation method, comprising:
propelling water through a first bore of a first portion of a nozzle assembly into a first chamber of a second portion of the nozzle assembly; and,
ejecting the water from the second portion, at an acute angle with respect to a longitudinal axis for the nozzle assembly passing through the first and second portions, through at least one second bore in communication with the first chamber.

12. The method of claim 11 wherein propelling water through the first bore includes propelling the water along the longitudinal axis.

13. The method of claim 11 wherein ejecting the water from the second portion through at least one second bore includes ejecting the water through a plurality of second bores.

14. The method of claim 11 wherein:
ejecting the water from the second portion at an acute angle with respect to the longitudinal axis includes:
injecting the water into a first port of the at least one second bore in communication with the first chamber; and,
ejecting the water from a second port of the at least one second bore in communication with an exterior surface of the nozzle assembly; and,
the first port is closer than the second port to the first portion.

15. The method of claim 11 wherein:
the at least one second bore includes a plurality of second bores;
each second bore includes a port in communication with an exterior surface of the nozzle;
the exterior surface includes a plurality of planar surfaces; and,
ejecting the water from the second portion through at least one second bore includes ejecting the water through a respective port from the plurality of second bores disposed in each exterior planar surface.

16. The method of claim 11 wherein:
each second bore includes a port in communication with an exterior surface of the nozzle;
the exterior surface includes a plurality of planar surfaces; and,
ejecting the water from the second portion through at least one second bore includes ejecting the water through a respective port from the at least one second bore disposed in some but not every exterior planar surface.

17. The method of claim 11 further comprising:
injecting the water ejected from the at least one second bore into a second chamber for a sleeve portion of the nozzle assembly at least partially enclosing the second portion;
ejecting the water from the sleeve portion through at least one third bore in communication with the second chamber; and,
adjusting the sleeve portion to select an alignment between the sleeve portion and the second portion.

18. The method of claim 17 wherein:
the at least one second bore includes a first port at the first chamber and a second port at an exterior surface of the second portion;
the at least one third bore includes a third port at the second chamber and a fourth port at an exterior surface of the sleeve portion; and,
adjusting the sleeve portion includes adjusting the sleeve portion to select an alignment between the second and third ports.

19. The method of claim 17 wherein adjusting the sleeve portion includes rotating the sleeve portion with respect to the second portion, the method further comprising fixing an alignment of the sleeve with respect to the second portion.

20. The method of claim 11 further comprising ejecting the water from the nozzle assembly through a third bore, in communication with the first chamber, and an exterior surface of the nozzle assembly at a top end of the second portion opposite a bottom end of the second portion connected to the first portion.

21. The method of claim 11 further comprising
disposing part of the first portion in a hole for a first portion of a staking element proximate a first end for the first portion, the hole connecting top and bottom surfaces of the first portion;
securing the first portion to a connecting element to fix the first segment with respect to the first portion and the connecting element; and,
disposing a stake portion of the staking element in a structure to fix a position of the nozzle assembly, the stake portion connected to the bottom surface proximate a second end of the staking element and extending away from the bottom surface.

22. An irrigation system, comprising:
a flexible hose including:
a wall forming an interior passageway; and,
at least one hole through the wall to the interior passageway; and,
at least one attachment element connected to the flexible hose and including:
a first section at a first end of the at least one attachment element, the first section at least partially disposed in the at least one hole and including an connection feature for fixing the attachment element with respect to the hose;
a second section at a second end of the at least one attachment element, opposite the first end, arranged to receive a plug or a water dispensing device; and,
a bore connecting the first and second ends, wherein each bore is in communication with the interior passageway.

23. The irrigation system of claim 22 wherein:
the connection feature is a first helical thread; and,
the portion arranged to receive a plug or a water dispensing device includes:
an interior wall forming a portion of the bore and including a second helical thread; or,
an exterior wall including a second helical thread.

24. The irrigation system of claim 22 wherein:
the at least one hole and the at least one attachment element include respective pluralities of holes and attachment elements; and,
respective distances between the holes are uniform; or,
respective distances between the holes vary.

25. A method of forming an irrigation system, comprising:
forming at least one hole through a wall of a flexible hose into an interior passageway formed by the wall;
disposing a first section of at least one attachment element in the at least one hole, the first section located at a first end of the at least one attachment element;
fixing the at least one attachment element with respect to the hose;
providing a bore in the at least one attachment element in communication with the passageway and a second end of the attachment element, opposite the first end of the attachment element; and,
connecting a plug or a water dispensing device to the second end.

26. The method of claim 25 wherein fixing the at least one attachment element with respect to the hose includes:
engaging a helical thread on the first section with the wall of the hose; or,
engaging a helical thread on the first section with an intervening device fixed to the wall of the hose.

27. The method of claim 25 wherein connecting a plug or a water dispensing device to the second end includes connecting the plug or the water dispensing device:
via a helical thread on an interior wall forming a portion of the bore; or,
via a helical thread on an exterior wall.

28. The method of claim 25 wherein the at least one hole and the at least one attachment element include respective pluralities of holes and attachment devices, the method further comprising:
forming the plurality of holes such that respective distances between the holes are uniform; or,
forming the plurality of holes such that respective distances between the holes vary.
